(19) United States
(12) Patent Application Publication
(10) Pub. No.: US 2008/0236732 A1
(43) Pub. Date: Oct. 2, 2008

(54) Method for the Production of a Steganographic Image on a Printing Material

(75) Inventor: Martin Schmitt-Lewen, Heidelberg (DE)

Correspondence Address: LERNER GREENBERG STEMER LLP, P O BOX 2480, HOLLYWOOD, FL, 33022-2480, US

(73) Assignee: HEIDELBERGER DRUCKMASCHINEN AG, Heidelberg (DE)

(21) Appl. No.: 12/058,199

(22) Filed: Mar. 28, 2008

(30) Foreign Application Priority Data
Mar. 30, 2007 (DE) DE 102007015843.4

(51) Int. Cl. B32B 37/00

(52) U.S. Cl. 156/230

(57) ABSTRACT

A method for the production of a steganographic image on a printing material includes bringing the printing material into contact with a transfer film after an adhesive raster corresponding to the steganographic image was previously applied to the printing material and/or the transfer film.

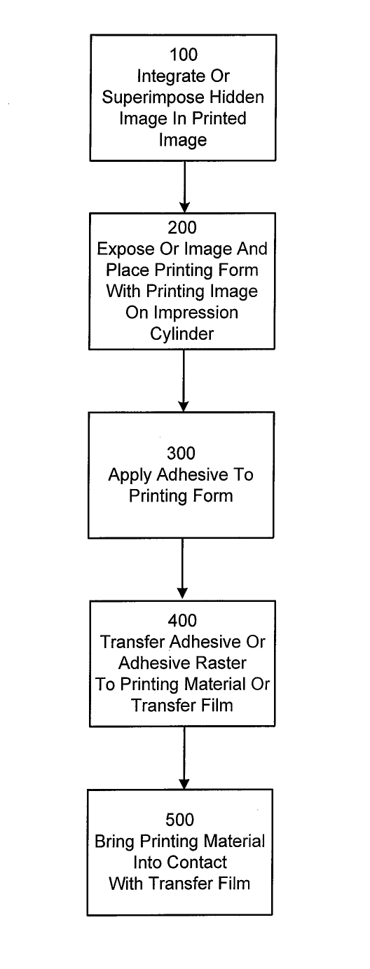

### CROSS-REFERENCE TO RELATED APPLICATION

This application claims the priority, under 35 U.S.C. §119, of German Patent Application DE 10 2007 015 843.4, filed Mar. 30, 2007; the prior application is herewith incorporated by reference in its entirety.

### BACKGROUND OF THE INVENTION

### Field of the Invention

The present invention relates to a method for the production of a steganographic image on a printing material.

It is already known to accommodate hidden images in printed images through the use of steganographic methods and, as a result, for example to produce printed security features on printed products.

German Published, Non-Prosecuted Patent Application DE 199 00 856 A1, corresponding to U.S. Pat. No. 6,104,812, discloses, for example, a method for encoding a rastered primary image with a likewise rastered secondary image. The two images are mixed and the secondary image is hidden in the primary image, so that the former cannot be perceived by the unsupported human eye. However, the secondary image can be made visible through the use of a decoding device, for example an optical lens. The method can be used to produce an anti-forgery security feature which can be printed onto a medium.

It is often the case that a plurality of security features that are different from one another are produced on one and the same printed product, in order to protect the product more effectively against counterfeiting. In that case, security features over an extremely wide range of technologies are used, such as is known from currency notes, for example (security threads, fluorescent printing inks and paper fibers, optically variable inks, look-through registers, holograms, micro text, guilloches, etc.). There is consequently a continual demand for novel security features which can be used on their own or in combination with security features that are already known.

Many of the known security features, for example holograms, are very complicated and at the same time expensive to produce. Moreover, many of the known security features, for example security threads, cannot be produced by printing, i.e. in particular not in a running printing process (“inline”). However, it is desirable to produce as many security features as possible simultaneously and preferably in the running printing process, since in that way the production costs as well as the production time can be reduced.

Furthermore, what is known as the cold film transfer process is known as a finishing method, in which a usually multilayer transfer layer is transferred from a transfer film to a printing material. A metal layer, for example an aluminum layer, which effects a metallic gloss of the transfer layer, is normally applied to the transfer film. In order to transfer the transfer layer to a printing material, the transfer film is led through a cylinder press nip together with the printing material. In order to ensure that a transfer of the transfer layer to the printing material can be carried out section by section or in accordance with an image, for example, the printing material is provided with adhesive section by section or in accordance with an image before the film transfer. The adhesive being used can be a colorless adhesive, an adhesive with a specific inherent color or else an adhesive colored to correspond with the film.

Such an apparatus is disclosed in European Patent EP 0 578 706 B1, corresponding to U.S. Pat. Nos. 5,565,054 and 5,735,994. In a first printing unit of the printing press, instead of an ink, an adhesive is transferred to a printing material. In order to apply the adhesive section by section, an appropriately imaged printing plate is clamped on in that printing unit and the adhesive is transferred to the printing material like a conventional offset printing ink. The printing material is then transported onward into a second printing unit. In this second printing unit, the impression cylinder and the blanket cylinder are constructed as a transfer unit. In the region of this second printing unit there is a film module having a transfer film supply spool and a transfer film collecting spool. In order to transfer the transfer layer to the printing material, the transfer film web and the printing material having the adhesive layer in some sections are led along their respective transport paths and through the transfer nip in such a way that the transfer layer rests on the adhesive layer. The transfer layer is then transferred to the printing material by pressure in the transfer nip. The transfer layer is taken cleanly off the transfer film in this case through the use of the adhesive. In a following press unit, action is then substantially exerted on the transferred transfer layer, so that permanent adhesion of the film overlay is achieved.

### BRIEF SUMMARY OF THE INVENTION

It is accordingly an object of the invention to provide a method for the production of a steganographic image on a printing material, which is different than and preferably overcomes the hereinafore-mentioned disadvantages of the heretofore-known methods of this general type and which can be produced by printing, that is to say in a printing press or during a printing process.

It is a further or alternative object of the present invention to devise a further method, preferably improved as compared with the prior art, which produces a steganographic image to be decoded in a simple manner.

It is a further or alternative object of the present invention to devise a further method, preferably improved as compared with the prior art, which produces a steganographic image which, in the decoded state, can be perceived easily by the naked eye.

With the foregoing and other objects in view there is provided, in accordance with the invention, a method for the production of a steganographic image on a printing material. The method comprises applying an adhesive raster corresponding to the steganographic image to the printing material and/or a transfer film, and

subsequently bringing the printing material into contact with the transfer film.

According to the invention, in order to produce the steganographic image, the application of an adhesive raster corresponding to the steganographic image is carried out, that is to say the steganographic image is transferred into an adhesive raster. Subsequently, according to the invention, in order to produce the steganographic image, a step of bringing into contact with a transfer film is carried out, that is to say the steganographic image transferred into an adhesive raster is further transferred into a raster of a medium transferred from a transfer film. Both steps can advantageously be carried out by printing, which is to say in a printing press or during a printing process.

A steganographic image produced in accordance with the invention is present on a printing material as a rastered medium transferred from a transfer film and therefore, given a suitable selection of the medium, is advantageously easy to decode and can easily be perceived with the naked eye.

In accordance with another mode of the invention, which is advantageous with regard to the ability to be decoded simply and perceived easily and is therefore preferred, a transfer layer of a carrier film of the transfer film is transferred to the printing material in accordance with the steganographic image. The transfer layer is used as a medium which can be transferred to the printing material in rastered form. The transfer layer as such is thus not transferred over the entire area but only partly, corresponding to the raster. Advantageously, the rastered transfer of the transfer film has the effect that, in the region of the steganographic image, the printing material also remains visible and can thus have a positive effect on the perceptibility of the steganographic image, for example through the use of a suitable selection of a low reflectance of the printing material.

In accordance with a further mode of the invention, which is advantageous with regard to the ability to be decoded simply and perceived easily and is therefore preferred, a transfer layer that reflects visible light, in particular reflects it highly, is transferred. Advantageously, the result achieved can be that the contrast of the decoded steganographic image in relation to the surrounding regions improves the perceptibility considerably.

In accordance with an added mode of the invention, which is advantageous with regard to the ability to be decoded simply and perceived easily and is therefore preferred, a glossy or reflective transfer layer is transferred. Advantageously, the result achieved can likewise be that the contrast of the decoded steganographic image in relation to the surrounding regions improves the perceptibility considerably. A glossy transfer layer can be produced, for example, by the introduction of glossy pigments, in particular pearlescent pigments, into the transfer layer. The perceptible effect effected by the glossy pigments (gloss, pearlescence, rainbow effect or the like) also not only improves the decorative character of the steganographic image but also its security character, since forgeries can be made more difficult by the increased expenditure on production and costs.

In accordance with an additional mode of the invention, which is advantageous and is therefore preferred, the transfer of the transfer layer is carried out under pressure.

In accordance with yet another mode of the invention, which is advantageous and is therefore preferred, the transfer of the transfer layer is carried out as a cold film transfer process.

In accordance with yet a further mode of the invention, which is advantageous and is therefore preferred, the adhesive raster is applied in a first printing unit and the printing material is brought into contact with the film in a second printing unit disposed downstream of the first printing unit in the transport direction of the printing material.

In accordance with yet an added mode of the invention, which is advantageous with regard to the transfer of the transfer layer of the transfer film and is therefore preferred, the adhesive raster is applied as a line raster.

In accordance with yet an additional mode of the invention, which is advantageous with regard to a possible optical perceptibility and is therefore preferred, the adhesive raster is applied as a dot raster.

In accordance with a concomitant mode of the invention, which is advantageous with regard to the ability to be decoded simply and perceived easily and is therefore preferred, the adhesive raster is brought into contact with a metallized plastic film. Advantageously, by using a metallized plastic film, the contrast of the decoded steganographic image in relation to the surrounding regions is increased further and the optical perceptibility is improved considerably.

Other features which are considered as characteristic for the invention are set forth in the appended claims. The invention and the advantageous developments thereof described herein also constitute advantageous developments of the invention in any desired combination with one another.

Although the invention is illustrated and described herein as embodied in a method for the production of a steganographic image on a printing material, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

The FIGURE of the drawing is a flow chart of a preferred embodiment of the method according to the invention for the production of a steganographic image on a printing material.

### DETAILED DESCRIPTION OF THE INVENTION

Referring now in detail to the single FIGURE of the drawing, there is seen a flow chart of a preferred embodiment of the method according to the invention for the production of a steganographic image on a printing material. A suitable printing material in this case is paper, foil or film, in each case as a sheet or web. Steganography designates generally the art or science of the storage and/or transfer of hidden information. Therefore, in the context of this invention, it is that information which a viewer cannot readily perceive on the printing material. Steganographic images produced in accordance with the invention are able firstly to increase the value of printed products and secondly to increase their security against forgery. The use which is primarily conceivable is for the production of security features that, for example, can be provided on packs of high-value products.

In a method step 100, at the level of the prepress stage, a steganographic image or feature (often also referred to as a “latent image” or by the anglicism “hidden image”) is first of all integrated into a printing image or superimposed on a printing image, with it being possible for the steganographic image to have text, image, drawing or pattern. For example, the steganographic image can be a line of text which is concealed in a photograph, or a symbol which is concealed in a neutral background.

The steganographic image preferably contains a first image region (a line of text in the first example given above) and the printing image to be superimposed contains a second image region bordering the first image region (a photograph in the first example given above). The first image region and the second image region have different rasters, for example as a result of the use of mutually different line or dot rasters, with it being possible for raster angle and/or raster frequency or raster width to be varied in each case. In this case, preference should be given to those raster variations in the steganographic image as compared with the “background” printed image which are imperceptible or barely perceptible to the naked eye.

For instance, in the first image region, a dot raster having a raster angle RW1 and in the second image region, a dot raster having a raster angle RW2≠RW1, can be used. Such a change in the raster angle is not visible at once using the naked eye, at least not if the position of the steganographic image in the printed image is unknown. However, the steganographic image can also be made visible to the human eye by using a decoder. Transparent films or foils having structuring, for example embossed structuring, matched to at least one of two raster frequencies RF1 or RF2 are, for example, suitable as decoders.

In a method step 200, a printing form having the printing image and thus also having the steganographic image integrated in the printing image, is exposed or imaged and the printing form is accommodated on an impression cylinder of a printing unit of a printing press, for example clamped on. Alternatively, the exposure can also be carried out directly in the printing press.

In a method step 300, the printing form is provided with an adhesive or an application of adhesive to the printing form is carried out through the use of a suitable applicator unit. Suitable adhesives are, for example, known adhesives for cold film transfer. The adhesive adheres to the printing form only at previously exposed points, so that an adhesive raster is produced on the printing form. This adhesive raster corresponds to the raster of the printing image and thus also to the varied raster of the steganographic image.

In a method step 400, the adhesive or the adhesive raster is transferred from the printing form to a printing material, preferably a paper sheet. Alternatively, although less preferred, the adhesive can also be transferred onto a transfer film (see method step 500 below). As a result, a rastered “adhesive image” having steganographic elements is, so to speak, produced on the printing material or the transfer film.

In a method step 500, the printing material is brought into contact with the transfer film. This can preferably be carried out in a press nip, i.e. under pressure, between a cylinder carrying the printing material and a cylinder carrying the transfer film. As a result of bringing into contact under pressure and the presence of the adhesive raster, a transfer layer, for example a coating of a carrier film of the transfer film, corresponding to the printing image and thus also to the steganographic image, is transferred to the printing material and removed from the carrier film of the transfer film. There is now a printed image and, consequently, also a steganographic image on the printing material in the form of a rastered transfer layer transferred and adhering through the use of the adhesive. The transfer of the transfer layer is preferably carried out as a cold film transfer process.

The adhesive raster is preferably applied in the method step 400 in a first printing unit of the printing press, and the printing material is brought into contact with the film in a second printing unit of the printing press disposed downstream of the first printing unit in the transport direction of the printing material, that is to say adhesive application and transfer layer transfer are preferably carried out in separate printing units. Alternatively, both can also be carried out in one printing unit.

The use of line rasters can be preferred when the line rasters come to lie substantially parallel to the running direction of the transfer film and the transfer layer can therefore be separated more easily from the transfer film.

A particular advantage of the invention is, then, that the steganographic image in the form of the transferred, rastered transfer layer is distinguished by good contrast, in particular if the transfer layer provided is a (glossy) transfer layer reflecting visible light. For example, a metallized plastic film can be used as the transfer film, so that the metallization is transferred to the printing material in rastered form as the transfer layer. The steganographic image can be made visible to the human eye by laying the decoder mentioned above in the method step 100 on the printed product, in particular at the position of the applied steganographic image. If the decoder film mentioned by way of example above in method step 100 is used, which is to say if the same is laid on the printed product and rotated, the steganographic image becomes visible at the correct rotational angle position of the decoder film, with good contrast in relation to the background of the printed image. The high contrast is brought about primarily by the high reflectance of the transferred carrier film transfer layer. As compared with known steganographic images produced through the use of printing ink, the steganographic image produced in accordance with the invention thus exhibits a property which is improved considerably with regard to perceptibility. In the correct decoder position, the steganographic image “hits” the viewer properly “in the eye”, that is to say it can be perceived easily with the naked eye.

A further advantage of the invention is the decorative effect which is additionally produced by the transfer layer transfer at the position of the steganographic image and which, in particular when reflecting materials are used, such as the aforementioned metallizations or glossy pigments, is reminiscent of the holograms which are known but far more costly to produce, and as a result further increase the value of the printed product produced and/or protect it against forgeries.

As an alternative to the above-described exemplary embodiment using cold film transfer, a method is also conceivable in which hot film transfer is used. In this case, the steganographic image is not transferred into an adhesive raster but into a rastered hot film embossing form. However, since the production of embossing forms with fine rasters is very complicated and costly, the above-described exemplary embodiment is preferred.

1. A method for the production of a steganographic image on a printing material, the method comprising the following steps:
applying an adhesive raster corresponding to the steganographic image to at least one of the printing material or a transfer film; and
subsequently bringing the printing material into contact with the transfer film.

2. The method according to claim 1, which further comprises transferring a transfer layer of a carrier film of the transfer film to the printing material in accordance with the steganographic image.

3. The method according to claim 2, which further comprises carrying out the transferring step by transferring a transfer layer reflecting visible light.

4. The method according to claim 2, which further comprises carrying out the transferring step by transferring a glossy transfer layer.

5. The method according to claim 2, which further comprises carrying out the transfer of the transfer layer under pressure.

6. The method according to claim 2, which further comprises carrying out the transfer of the transfer layer as a cold film transfer process.

7. The method according to claim 1, which further comprises:
carrying out the step of applying the adhesive raster in a first printing unit; and
carrying out the step of bringing the printing material into contact with the film in a second printing unit disposed downstream of the first printing unit in a transport direction of the printing material.

8. The method according to claim 1, which further comprises carrying out the step of applying the adhesive raster as a line raster.

9. The method according to claim 1, which further comprises carrying out the step of applying the adhesive raster as a dot raster.

10. The method according to claim 1, which further comprises bringing the adhesive raster into contact with a metallized plastic film.
